(19) United States
(12) Patent Application Publication
(10) Pub. No.: US 2011/0089152 A1
(43) Pub. Date: Apr. 21, 2011

(54) METHOD AND SYSTEM FOR EXPOSING DELICATE STRUCTURES OF A DEVICE ENCAPSULATED IN A MOLD COMPOUND

(75) Inventor: Gregory B. Anderson, Orlando, FL (US)

(73) Assignee: Control Systemation, Inc., Orlando, FL (US)

(21) Appl. No.: 12/580,652

(22) Filed: Oct. 16, 2009

(51) Int. Cl. B23K 26/00

(52) U.S. Cl. 219/121.69; 219/121.68

(57) ABSTRACT

A system utilizes a laser to remove the mold compound of an IC without damaging the internal die, wire leads, solder connections and any other critical structures encapsulated within the mold compound, thereby leaving them available for the provisional and electrical analysis. A laser beam is focused through appropriate optics onto a plane corresponding to the surface of an IC. A layer of material which is opaque at the wave length of the laser beam is applied at the surface of the IC chip to be ablated prior to each pass of the laser. A spray nozzle may be provided to move in synchronous motion ahead of the laser being to apply coat of the opaque material.

### BACKGROUND OF THE INVENTION

The present invention relates to methods and systems for using an ablating laser in preparing an integrated circuit for failure analysis, in particular, for preparing an electrical device or circuitry having components encapsulated in a mold compound containing a glass or silicon impurities.

Integrated circuits fail. However, once they fail, it is often necessary to determine what causes such failure as it may trigger a product recall leading to corrective action. In failure analysis, each component of the integrated circuit is tested to determine whether that particular element is the cause of the failure. The basic structure of the typical integrated circuit (IC) includes a rectangular, semiconductor die or chip surrounded by and connected to a number of fine wire leads which are further connected to a surrounding frame of thicker metallic traces which in turn form the external pins of the IC. With the exception of the external pins, the entire assembly is typically encapsulated in a package formed from a mold compound. When an IC is installed on a circuit board, the pins of the IC are typically soldered to corresponding pads on the circuit board.

In order to identify the cause of the failure, visual inspection is often required. This includes inspection of the die, the wire leads, the pin frame and the soldering connections. Additionally, physical access to interior points may also be needed to isolate problems. However, access to these specific IC structures is prevented by the protective encapsulated mold compound.

It is necessary to remove the mold compound without damaging the individual components of the IC to be inspected. It is known from the inventor's issued U.S. Pat. No. 7,271,012 to use an ablating laser to remove the compound without damaging the underlying structure. As shown in FIG. 1, the prior art solution is a system, generally indicated as 10, utilizing a laser beam 12 focused through appropriate optics 16 onto a plane corresponding to the surface 16 of an IC 14 to selectively remove the mold compound therefrom. The focused laser beam 12 is typically moved across a selected area of the IC surface in a pattern removing the mold compound in layers, penetrating deeper into the compound with each pass.

Although the prior art solution has been satisfactory, it suffers from the disadvantage that it cannot adequately ablate some resin compounds which utilize glass or silicon fillers which are too large or too numerous. Since the invention of the prior art system, IC chip manufacturers have been utilizing newer resin compounds made with glass and silicon fillers. The prior art system relies on a sufficient energy density of the focused laser beam at the surface of IC 14 to be ablated. However, as seen in FIG. 2, glass 20 within the compound 24 of IC 14 diffuses the laser energy making it unfocused, reducing the energy density to a point below that sufficient to ablate the compound. Raising the power of the beam sufficient to overcome the energy loss as a result of the diffusion will result in destruction of the sensitive IC components where the beam is not diffused, destroying or damaging the IC chip to a point where failure analysis cannot be performed.

Accordingly, it is desirable to provide a system and method for overcoming the shortcomings of the prior art.

### SUMMARY OF THE INVENTION

A system utilizes a laser to remove the mold compound of an IC without damaging the internal die, wire leads, solder connections and any other critical structures encapsulated within the mold compound, thereby leaving them available for analysis. A laser beam is focused through appropriate optics onto a plane corresponding to the surface of an IC. A layer of material which is substantially opaque at the wave length of the laser beam is applied at the surface of the IC chip to be ablated at each pass or at intervals of each pass that are appropriate to perform a proper ablation.

In a preferred embodiment, a spray nozzle may be provided to move in synchronous motion ahead of the laser beam path to apply a coat of the opaque material.

### BRIEF DESCRIPTION OF THE DRAWINGS

FIG. 1 is a schematic drawing of the prior art ablation system;

FIG. 2 is a schematic drawing showing the effect of the glass filler on the ablating laser beam of the prior art;

FIG. 3 is a block diagram of a system constructed in accordance with the present invention;

FIG. 4 is a schematic diagram showing ablation of a compound mold in accordance with the invention;

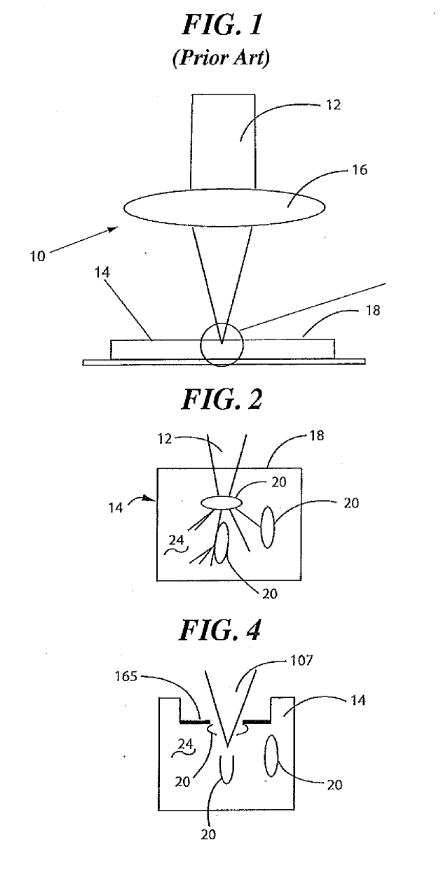

### DETAILED DESCRIPTION OF THE PREFERRED EMBODIMENT

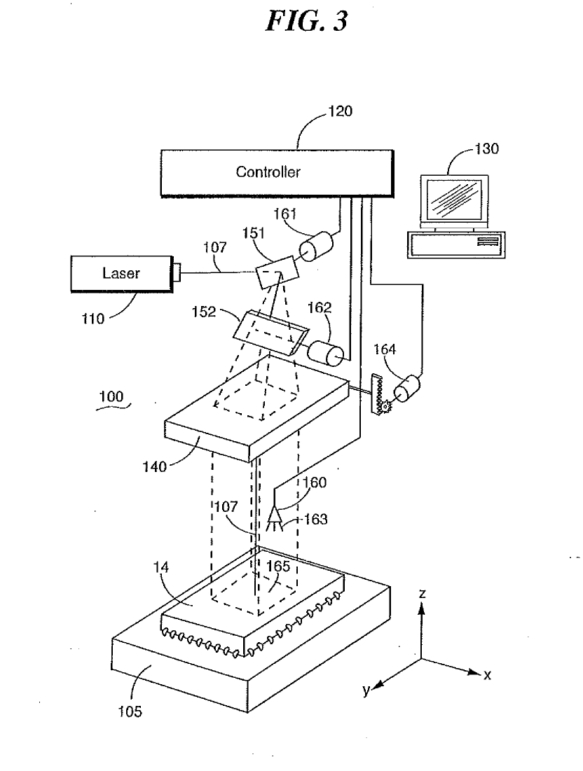

FIG. 3 is a block diagram of an exemplary embodiment of a system 100 in accordance with the present invention. A device to be analyzed, such as an integrated circuit (IC) 14, is placed on a platform 105 upon which a laser beam 107 generated by a laser 110 is steered and focused by a pair of reflective paddles 151 and 152 and a lens element 140. Operation is controlled by a controller 120 which may be coupled to a user interface 130 for human interaction. For example, the controller 120 and user interface 130 may be part of a workstation, personal computer or the like or may be housed separately.

During operation, the IC 14 is stationary as the beam 107 is moved over a selected portion of the surface of the IC in a selected pattern. At any one instant, the laser beam 107 impinges on one point on the surface of the IC 101. To the human eye, however, the beam may appear as a line or as a rectangle on the surface of the IC 101, depending on how fast the beam 107 is steered over the surface of the IC 101. As the beam 107 impinges on the surface of the IC 101, a small quantity of the molding compound at the point of impingement is ablated and thus removed. As the beam 107 is steered over the IC's surface, mold compound is removed in the pattern in which the beam 107 is steered.

The pattern traced by the laser beam 107 (or the pattern of ablation) can be selected to cover any desired portion of the surface of the device, having any of a variety of geometric shapes (e.g., rectangle, circle). The pattern is preferably selected so as to remove a uniform layer of material with each pass of the laser over the pattern. Successive layers of material are removed with successive passes of the laser over the pattern. As each layer of material is removed, the laser beam 107 is directed onto the newly exposed surface of the device 101 to remove the next layer of compound 24. The ablation process can be stopped at any point, Thus, in addition to removing material from a desired area of the device 101, the system can also remove the material to a desired depth.

The laser beam 107 generated by the laser source is deflected first by the reflective paddle 151 which is rotated about a first axis by an actuator 161. The paddle 151 deflects the beam 107 onto the reflective paddle 152, which is oriented substantially perpendicular to the paddle 151. The paddle 152 deflects the beam onto the lens element 140. Typically, the actuator 161 will cause the paddle 151 to rotate in an oscillatory pattern so that the beam will travel along a line on the paddle 152. Likewise, an actuator 162 will cause the paddle 152 to rotate in an oscillatory pattern so that the beam will travel along a two-dimensional raster pattern on the lens element 140. The reflective paddles 151 are 152 are preferably thin, having low mass. The actuators 161, 162 and 164 are preferably high-speed galvanometer motors. The combination of low mass reflectors and high speed motors allows the focused laser beam to travel at speeds up to several thousand inches per second.

The actuators 161 and 162 are under the control of the controller 120. A laser steering sub-system that can be used in the present invention, including the paddles 151, 152, the actuators 161, 162, all of the necessary control circuitry and associated software is available from Cambridge Technology, Inc. of Cambridge, Mass.

Regardless of the orientation of the paddles 151 and 152, and the length of the path traveled by the laser beam 107, the lens element 140 serves to focus the laser beam onto a single plane. Lens element 140 is moved by an actuator 140. The lens element 140 can be, for example, a “flat field lens” or a “telecentric lens” which takes the laser beam input at an angle and focuses it in a plane on the output of the lens. Sources for such optics include Sil and Rodenstock of Germany.

To prevent diffusion of laser beam 107 within IC 14, a layer 165 of material 163, substantially opaque at the wavelength of laser beam 107, is applied to the surface of IC 14 to be ablated ahead of ablation by laser beam 107. In one embodiment, a spray head 160 is provided under the control of controller 120 and sprays the opaque material 163 onto the surface of IC 14. Spray head 160 is disposed within system 100 ahead of the travel path of laser beam 107 to apply opaque layer 165 ahead of laser beam 107 impinging on IC 14.

It should be noted, that spray head 160 may be an atomizer, a dropper, or any structure having porous opening allowing a fine solid or liquid to pass there through, or any mechanism capable of applying a substantially uniform layer of a material which is substantially opaque at the wavelength of beam 107. Furthermore, spray head 160 is used in a preferred embodiment. However, any structure may be used including manually applying layer 165 of substantially opaque material 163 ahead of the sweep of beam 107 by way of dropper, spray bottle, atomizer, applicator brush or the like.

By moving the laser beam 107 over the surface of the IC 14 at a high speed, the amount of time that the laser beam dwells at each point is very small, thus minimizing any damage that the laser may do to the delicate underlying structure that the ablation process seeks to expose. The resultant heat affected zone (HAZ) is thus kept very small (e.g., less than 1 micron). Effectively all of the mold compound of an IC can be removed leaving a functional “skeleton” of the components beneath to the point that they are electrically intact and even in a condition to be powered up.

It is to be understood that within the scope of the invention, the movement of laser beam 107 relative to IC 14 can be conducted by moving laser beam 107 by manipulation of laser beam 107 or the intervening mirrors. However, it may also be accomplished by moving IC chip 14 by moving platform 105. What is required by the invention is relative movement between laser beam 107 and an upper surface of IC 14 and the application of the substantially opaque material 163.

Another consideration is the wavelength of the laser emission used. The wavelengths of green (˜532 nm), Ultraviolet (UV) (˜266 nm), Infrared (IR) (˜1,064 nm), and CO2 (˜10,640 nm), among others, can be used. The best wavelength for an application depends on the type of material to be ablated and the composition of the underlying structures that are to be exposed. The choice of material 163 is a function of the wavelength.

For ICs using common mold compounds, IR wavelengths have been found to work well, without damaging the more fragile underlying structures, i.e., the fine copper wires which attach the die to the IC pins. Lasers with a wavelength of approximately 1319 nm can also be used for ICs, as it does not tend to damage the dies, which are primarily composed of silicon. The fine wires are not affected by IR or 1319 nm wavelengths as much as they may be by other wavelengths such as green. For instance, copper tends to reflect IR wavelengths. Therefore, by using IR wavelengths, damage to these components is further diminished, as is the HAZ. Thus, by selecting the appropriate laser wavelength based on the composition of the device to be exposed, the process of the present invention can be optimized. The present invention is not limited to a laser of any particular wavelength.

In a preferred embodiment, the wavelength of the laser emission is in the infrared spectrum; roughly 1,064 nm. As a result, the opaque material in a preferred non limiting embodiment may be any black material. Either a liquid or solid black dye may be used. By way of example, black graphite powder or paste may used, or if a liquid is utilized, then materials such as black magic marker, ink, or even black food coloring. In one non limiting embodiment, the opaque material is also non-toxic so that no toxic fumes are released during the ablation process.

As seen in FIG. 4, the utilization of opaque layer 165 changes a previously diffusive layer (FIG. 2) to an opaque layer. A compound layer at which beam 107 is focused is now a heterogeneous layer and maintains the quality of light as the laser interacts with the compound ablating layer 165 and the adjacent layer of compound 24 with it. With each pass of beam 107, or at intervals of each pass that are appropriate to perform a proper ablation, a new layer 165 is applied.

While this invention has been particularly shown and described with reference to the preferred embodiments thereof, it will be understood by those skilled in the art that various changes in form and detail may be made therein without departing from the spirit and scope of the invention encompassed by the appended claims. It is further to be understood that all values are approximations, and are provided for purposes of description.

What is claimed as new and desired to be protected by Letters Patent of the United States is:

1. An apparatus for exposing a structure encapsulated within a material comprising:
a laser beam source for emitting a laser beam;
a control mechanism to cause the laser beam to traverse the structure encapsulated within the material and control the position and depth of the laser beam, so as to expose, by ablation, at least an underlying portion of the structure without damaging the underlying portion; and
an applicator for applying to the structure, a material substantially opaque to the laser beam emitted from the laser beam source onto the structure ahead of the laser beam along a path of traverse of the laser beam.

2. The apparatus of claim 1, wherein the material is at least one of a black graphite powder, ink or dye.

3. The apparatus of claim 2, wherein the material is a non-toxic material.

4. The apparatus of claim 3, wherein the material is a liquid.

5. The apparatus of claim 1, wherein the applicator is an atomizer.

6. The apparatus of claim 1, wherein the control mechanism steers the laser beam source onto the structure to emit the laser beam onto the structure.

7. The apparatus of claim 1, wherein the structure encapsulated with material is moved relative to the laser beam source, and the laser beam is fixed in position.

8. A method for exposing a structure encapsulated with a material comprising:
generating a laser beam;
directing the laser beam onto the structure encapsulated with the material, the laser beam tracing a path across the structure encapsulated within the material;
applying a material which is substantially opaque to the laser beam to a surface along the path to be traversed by the laser beam prior to the laser beam traversing the path; and
ablating the material with the laser beam after the substantially opaque material has been applied, so as to expose at least an underlying portion of the structure without damaging the underlying portion.

9. The method of claim 8, wherein the laser beam has a wavelength of about 1,064 nm.

10. The method of claim 1, further comprising the step of providing a relative displacement between the laser beam and the encapsulated structure to ablate the material over an area as the laser beam traverses the path.

11. The method of claim 10, wherein the encapsulated structure is moved and the laser beam is fixed.

12. The method of claim 9, wherein the laser beam is movably steered onto the encapsulated structure.

13. The method of claim 8, wherein the substantially opaque material is a liquid.

14. The method of claim 8, wherein the substantially opaque material is a fine solid.

15. The method of claim 8, wherein the substantially opaque material is non-toxic.

16. The method claim 13, wherein the substantially opaque material is applied by one of spraying, atomizing and painting.

17. A method for exposing a structure encapsulated within a material comprising:
generating a laser beam;
directing the laser beam onto the structure encapsulated with the material, the laser beam tracing a path across the structure encapsulated within the material;
applying a material which is substantially opaque to the laser beam to a surface along the path to be traversed by the laser beam prior to the laser beam traversing the path; and
ablating the material with the laser beam as the laser beam traces the path across the structure encapsulated within the material so as to expose at least an underlying portion of the structure without damaging the underlying portion.

18. The method of claim 17, wherein the laser beam has a wavelength of about 1,064 nm.

19. The method of claim 17, wherein the substantially opaque material is a liquid.

20. The method claim 17, wherein the substantially opaque material is applied by one of spraying, atomizing and painting.
